(19) United States
(12) Patent Application Publication
(10) Pub. No.: US 2011/0063878 A1
(43) Pub. Date: Mar. 17, 2011

(54) POWER-SUPPLY CONTROLLER

(75) Inventor: Shea PETRICEK, Dallas, TX (US)

(73) Assignee: INTERSIL AMERICAS INC., Milpitas, CA (US)

(21) Appl. No.: 12/883,057

(22) Filed: Sep. 15, 2010

Related U.S. Application Data
(60) Provisional application No. 61/243,290, filed on Sep. 17, 2009.
(60) Provisional application No. 61/306,130, filed on Feb. 19, 2010.

(51) Int. Cl. H02M 3/335

(52) U.S. Cl. 363/21.12

(57) ABSTRACT

An embodiment of a controller for a power supply includes circuitry that is operable to allow the power supply to operate as follows. During a first portion of a supply period, a first current flows through a first winding of the power supply, through a second winding of the power supply, and to an output node of the power supply. And during a second portion of the supply period, a second current flows through the first winding, through a third winding of the power supply, and to the output node. Each of the first, second, and third windings may be non-electrically isolated from one or more of the other windings during one or more portions of the supply period. Furthermore, the first, second, and third windings may be magnetically coupled to one another. For example, in an embodiment, such a controller may be part of a DC-DC converter that may be more efficient, and that may have reduced interdependence between output-signal ripple and transient response, than a conventional buck converter.

### CLAIM OF PRIORITY

The present application claims the benefit of copending U.S. Provisional Patent Application Ser. No. 61/243,290 filed Sep. 17, 2009; the present application also claims the benefit of copending U.S. Provisional Patent Application Ser. No. 61/306,130, filed Feb. 19, 2010; all of the foregoing applications are incorporated herein by reference in their entireties.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

An embodiment of a controller for a power supply includes circuitry that is operable to allow the power supply to operate as follows. During a first portion of a supply period, a first current flows through a first winding of the power supply, through a second winding of the power supply, and to an output node of the power supply. And during a second portion of the supply period, a second current flows through the first winding, through a third winding of the power supply, and to the output node. Each of the first, second, and third windings may be electrically coupled to one or more of the other windings during one or more portions of the supply period. Furthermore, the first, second, and third windings may be magnetically coupled to one another.

For example, in an embodiment, such a controller may be part of a DC-DC voltage-step-down converter that may more efficient, and that may have less interdependence between an output-signal ripple and a transient response, than a conventional buck converter.

### BRIEF DESCRIPTION OF THE DRAWINGS

FIG. 1 is a schematic diagram of an embodiment of a DC-DC-converting power supply and a load powered by the supply.

FIG. 2 is timing diagram of signals generated during operation of an embodiment of the power supply of FIG. 1.

FIG. 3 is a schematic diagram showing current flows that occur while an embodiment of the power supply of FIG. 1 is operating during a first inductor-charging portion of the supply period of FIG. 2.

FIG. 4 is a schematic diagram showing current flows that occur while an embodiment of the power supply of FIG. 1 is operating during a first inductor-discharging portion of the supply period of FIG. 2.

FIG. 5 is a schematic diagram showing current flows that occur while an embodiment of the power supply of FIG. 1 is operating during a second inductor-charging portion of the supply period of FIG. 2.

FIG. 6 is a schematic diagram showing current flows that occur while an embodiment of the power supply of FIG. 1 is operating during a second inductor-discharging portion of the supply period of FIG. 2.

FIG. 7 is a schematic diagram showing current flows that occur while an embodiment of the power supply of FIG. 1 is operating during a high-output-current period of FIG. 2.

FIG. 8 is a schematic diagram of an embodiment of a power supply that includes two or more of the power-delivery circuits of FIG. 1.

FIG. 9 is a diagram of an embodiment of a system that incorporates either or both of the power supply of FIG. 1 and the power supply of FIG. 8.

### DETAILED DESCRIPTION

DC-DC converters may be used for converting an input DC signal (e.g., an input voltage or input current) having a first level into a regulated output DC signal (e.g., an output voltage or output current) having a second level.

For example, a conventional buck converter converts an input DC voltage having a higher level (e.g., 5 Volts (V)) into a regulated output DC voltage having a lower level (e.g., 1.3 V).

Unfortunately, such a conventional buck converter may have problems including relatively poor conversion efficiency and a relatively high level of interdependence between the output-voltage ripple amplitude and the step-up load-transient response time—a step-up load transient is a relatively sudden and significant increase in the load current.

Regarding poor conversion efficiency, in a conventional buck converter, the high-side transistors are subjected to lossy switching transitions as the phase inductor forces both full load current and full input voltage on each transition. Further, the high-side transistor is forced to supply reverse-recovery current for the freewheeling diode, and this adds additional loss. These losses also scale with frequency and input voltage.

And regarding the interdependence between the output-voltage ripple amplitude and the step-up load-transient response time, the ripple amplitude increases as Vin increases, and decreases as the value of the phase inductor increases; and the transient response time decreases as Vin increases, and increases as the value of the phase inductor increases. Therefore, changes in Vin and in the inductor value that improve (i.e., reduce) the ripple amplitude may worsen (i.e., lengthen) the transient response, and changes in Vin and in the inductor value that improve (i.e., shorten) the transient response may worsen (i.e., increase) the ripple amplitude. Consequently, a buck-converter designer may be forced to choose a middle ground in which neither the ripple amplitude nor the or transient response is optimal.

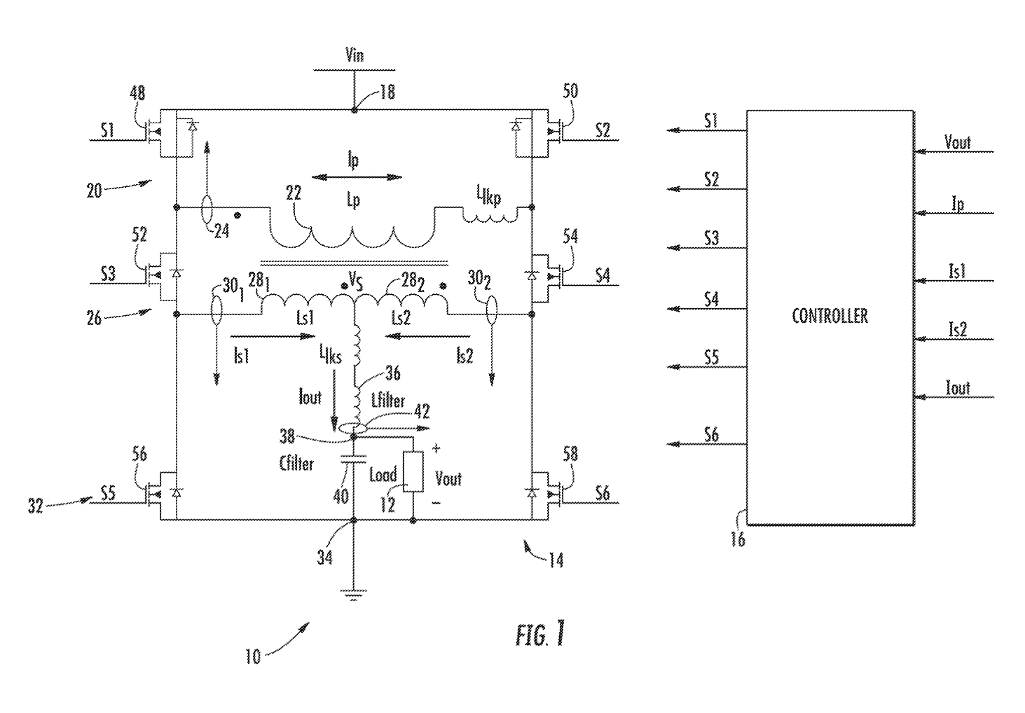

FIG. 1 is a schematic diagram of an embodiment of a DC-DC converting power supply 10 for providing a regulated output voltage Vout to a load 12. As discussed below, the power supply 10 may have improved conversion efficiency as compared to a conventional DC-DC converter such as a conventional buck converter, and may reduce the interdependence between the output-voltage ripple amplitude superimposed on Vout and the supply's step-up load-transient response.

The power supply 10 includes a power-delivery circuit 14, and includes a controller 16 for controlling the operation of the power-delivery circuit.

The power-delivery circuit 14 includes a first input node 18, a first power-supply stage 20, a first, e.g., primary, winding 22, a first, e.g., primary, current sensor 24, a second power-supply stage 26, second and third, e.g., secondary, windings 28₁ and 28₂, magnetically coupled to each other and to the primary winding 22 second and third, e.g., secondary, current sensors 30₁ and 30₂, a third power-supply stage 32, a reference node 34, an output filter inductor 36, an output node 38, an output filter capacitor 40, and an output current sensor 42.

The first input node 18 receives an input voltage Vin, which has a greater magnitude than Vout. For example, Vin may be 5 V, and Vout may be 1.3 V. The power-delivery circuit 14, in response to the controller 16, effectively steps down Vin to generate Vout.

The first power-supply stage 20 includes switching transistors 48 and 50, which, in response to switching-control signals S1 and S2 from the controller 16, couple and uncouple respective nodes of the primary winding 22 to and from the input node 18. In an embodiment, the transistors 48 and 50 are N-channel MOS-type power transistors having their substrates tied to their sources such that the transistor body diodes have their cathodes coupled to the input node 18.

The primary winding 22 may be modeled to include a magnetizing inductance Lp and a leakage inductance Lₗₖₚ, and conducts a current Ip, which may flow in either direction depending on the operational state of the power supply 10 as discussed below.

The primary current sensor 24 provides to the controller 16 at least one signal that indicates the magnitude and direction of the primary current Ip.

The second power-supply stage 26 includes switching transistors 52 and 54, which, in response to switching-control signals S3 and S4 from the controller 16, couple and uncouple respective nodes of the primary winding 22 to and from respective nodes of the secondary windings 28₁ and 28₂. In an embodiment, the transistors 52 and 54 are N-channel MOS-type power transistors having their substrates tied to their sources such that the transistor body diodes have their anodes coupled to the respective nodes of the secondary windings 28₁ and 28₂.

The secondary windings 28₁ and 28₂ may be modeled to include respective magnetizing inductances Ls₁ and Ls₂ and a shared leakage inductance Lₗₖₛ, and conduct respective currents Is₁ and Is₂, which typically flow toward the output node 38. Each of the secondary windings 28 includes a common node (the output node of the leakage inductance Lₗₖₛ) coupled to the filter inductor 36, and includes a respective node coupled to the second and third power-supply stages 26 and 32.

The secondary current sensor 30₁ provides to the controller 16 at least one signal that indicates the magnitude and direction of the secondary current Is₁; likewise, the secondary current sensor 30₂ provides to the controller at least one signal that indicates the magnitude and direction of the secondary current Is₂.

The third power-supply stage 32 includes switching transistors 56 and 58, which, in response to switching-control signals S5 and S6 from the controller 16, couple and uncouple respective nodes of the secondary windings 28₁ and 28₂ to and from the reference node 34. In an embodiment, the transistors 56 and 58 are N-channel MOS-type power transistors having their substrates tied to their sources such that the transistor body diodes have their anodes coupled to the node 34.

The reference node 34 receives a reference voltage such as ground as shown in FIG. 1. Although shown coupled to the reference node 34, the load 12 may be coupled to a node other than node 34.

The output filter inductor 36 and the output filter capacitor 40 are optional components that may further smoothen Vout by reducing the ripple component of the voltage at the output of the leakage inductance Lₗₖₛ.

The output current sensor 42 provides to the controller 16 at least one signal that indicates the magnitude and direction of the output current Iout through the filter inductor 36 (or through the leakage inductance Lₗₖₛ if the filter inductor 36 is omitted).

Still referring to FIG. 1, the controller 16 receives the signals Vout, Ip, Is₁, Is₂, and Iout (or signals representative of these signals) the power-delivery circuit 14, and generates the switching signals S1-S6 in response to these fed back signals. For example, the controller 16 may compare Vout (or a signal representative of Vout) to a reference signal (not shown in FIG. 1), and adjust the on and off times of at least one of the signals S1-S6 to regulate Vout to a set voltage level. The controller 16 may also compare the secondary-winding currents Is₁ and Is₂ to Iout, and adjust the on and off times of at least one of the signals S1-S6 to balance the secondary-winding currents such that the average level of Is₁ is substantially equal to the average level of Is₂. Furthermore, the controller 16 may monitor Ip, Is₁, Is₂, or Iout for an over-current condition, and may adjust the on and off times of at least one of the signals S1-S6 in response to a detected over-current condition to prevent damage to the power-delivery circuit 14 or to the load 12. Moreover, the controller 16 may monitor Vout for an over-voltage condition, and may adjust the on and off times of at least one of the signals S1-S6 in response to a detected over-voltage condition to prevent damage to the power-delivery circuit 14 or to the load 12. Because conventional techniques for voltage regulation, phase-current balancing, over-current protection, and over-voltage protection exist, further details of these techniques are omitted for brevity.

And the load 12 may be an integrated circuit (IC) such as a processor, memory, or system on a chip (SoC).

Still referring to FIG. 1, the interaction of the magnetically coupled primary winding 22 and the secondary windings 28₁ and 28₂, may improve the efficiency of the power supply 10, and may reduce the dependency between the amplitude of the Vout ripple and the step-up-load-transient response of the power supply as compared to a conventional buck converter.

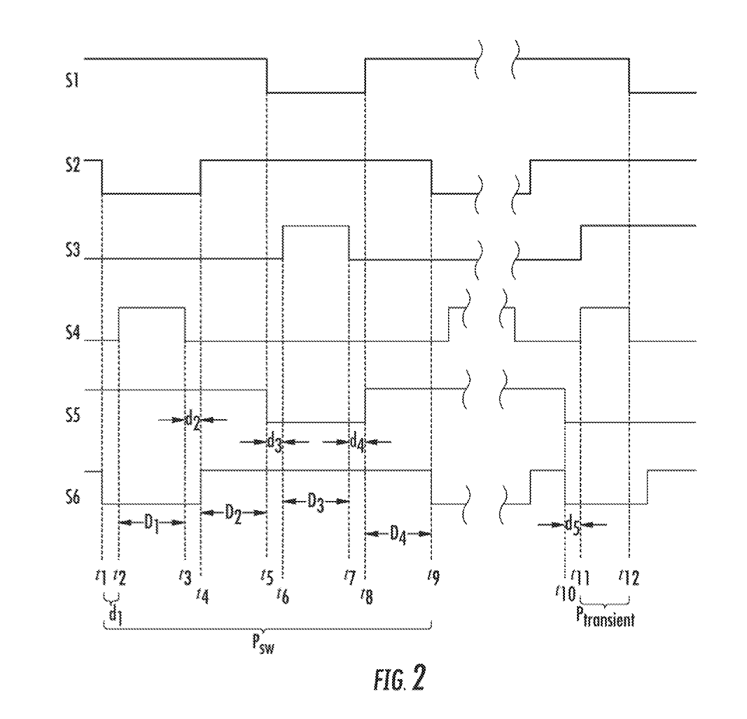

The interaction of the primary and secondary windings 22, 28₁, and 28₂ may reduce the current through the transistors 48, 50, 52, and 54—these transistors may be considered to be akin to the high-side transistors of a conventional buck converter—and thus may increase the efficiency of the power supply 10 by reducing the power dissipated by these transistors. For example, during a state of the power supply 10 in which the primary winding 22 and the secondary winding 28₁ are being charged by a current Ip=Is₁ flowing from Vin, through the closed transistor 50 (the transistor 48 is open), through the primary winding 22, through the closed transistor 52 (the transistor 54 is open), and through the secondary winding 28₁, the total current Iout is equal to the sum of Is₁ and Is₂=Ip(Np+Ns₁)/Ns₂, where Np is the number of turns in the primary winding 22, Ns₁ is the number of turns in the secondary winding 28₁, and Ns₂ is the number of turns in the secondary winding 28₂ (the transistor 58 may also be closed to allow the magnetically induced current Is₂ to bypass the body diode of this transistor). If, for example, Np=8 and Ns₁=Ns₂=1, then Iout=Ip+9·Ip=10·Ip. So for a given output current Iout, Ip=Iout·Ns₂/(Np+Ns₁+Ns₂), or Ip=Iout/10 in the given example. In contrast, the current through a high-side transistor of a conventional buck converter is equal to Iout divided by the number of phases in the buck converter. Consequently, because the power dissipated in the closed transistors 50 and 52 is proportional to Ip², and because the current Ip is reduced from Iout by the transformer turns ratio per above, the combined power dissipated by the transistors 50 and 52 may be less than the power dissipated by a high-side transistor of a conventional buck converter for a same load current and transistor-on time. Furthermore, that the transistors 50 and 52 may achieve ZVS when turning on may also reduce the power dissipated by these transistors as compared to a high-side transistor of a conventional buck converter. A similar analysis applies during a state of the power supply 10 in which the transistors 48, 54, and 56 are closed and the transistors 50, 52, and 58 are open, in which case Ip=Iout·Ns₁/(Np+Ns₁+Ns₂). If Ns₁=Ns₂, then Iout is the same during both of the above-described operational states of the power supply 10. Furthermore, the above-described operational states of the power supply 10 are further described below in conjunction with FIGS. 2-7.

Still referring to FIG. 1, the interaction of the primary and secondary windings 22, 28₁, and 28₂ may also reduce the interdependency of the amplitude of the ripple voltage superimposed on Vout and the step-up load-transient response of the power supply 10. While the transistors 50, 52, and 58 are closed and the transistors 48, 54, and 56 are open, a voltage Vs at the node common to the secondary windings 28₁ and 28₂ equals Vin×Ls₁/(Lp+Ls₁+Ls₂)=Vin×Ns₁/(Np+Ns₁+Ns₂) (where the primary and secondary windings are formed from wires have similar inductive properties); for example, wherein Np=8 and Ns₁=Ns₂=1, then Vs=Vin/10. A similar analysis may be made for the state of the power supply 10 in which the transistors 48, 54, and 56 are closed, and the transistors 50, 52, and 58 are open. Therefore, because the output ripple amplitude superimposed on Vout decreases as Vs decreases, the output ripple amplitude also decreases as the transformer turns ratio increases (for a given Vin). Furthermore, the step-up load-transient response time increases with the value of the secondary leakage inductance Lₗₖₛ and with the value of the filter inductor 36 (if present). Consequently, because the transformer turns ratio is independent of the secondary leakage inductance Lₗₖₛ and the inductance L_{filter} of the filter inductor 36, a designer may adjust the output ripple amplitude and the step-up load-transient response time independently of one another. That is, the transformer turns ratio of the power supply 10 is an additional variable that a conventional buck converter does not have, and that allows a designer to adjust, among other things, the output ripple and transient response time. For example, suppose a designer wants to reduce the transient-response time of the supply 10 for a given value of Vin by decreasing the secondary-leakage/output inductance Llks+Lfilter. In a conventional buck converter and for a given value for Vin, this would also increase the output voltage ripple. But in the power supply 10, for a given value of Vin, the designer may increase the transformer turns ratio to reduce the value of Vs, and to thus offset the would-be increase in the output ripple caused by the lower secondary-leakage/output inductance. Or, suppose a designer wants to reduce the output-ripple magnitude for given values of Vin, phase inductance, and switching frequency. In a conventional buck converter, this would be difficult to impossible to do. But in the power supply 10, the designer may achieve a reduction in output ripple without changing the value of Vin, the value of the secondary-leakage/output inductance, or the switching frequency by increasing the transformer turns ratio to reduce Vs.

Still referring to FIG. 1, alternate embodiments of the power supply 10 are contemplated. For example, at least one of the transistors 48, 50, 52, 54, 56, and 58 may be any suitable type other than an N-channel MOS power transistor, and, for MOS-type ones of these transistors, the body diodes may be eliminated. Furthermore, there may be more than one primary winding 22 and there may be fewer or more than two secondary windings 28. Moreover, at least one of the windings 22 and 28 may not be magnetically coupled to the other windings. In addition, at least one of the current sensors 24, 30, and 38 may be omitted. Furthermore, the filter inductor 36 may be omitted. Moreover, the supply 10 may include more than one filter inductor 36 and more than one filter capacitor 40 arranged in any suitable topology. In addition, the controller 16 may receive fewer than all of the signals Vout, Ip, Is₁, Is₂, and Iout, or may receive additional signals. Furthermore, the power-supply 10 may regulate the output current Iout instead of the output voltage Vout.

FIG. 2 is a timing diagram of the switching signals S1-S6 during operation of an embodiment of the power supply 10 of FIG. 1.

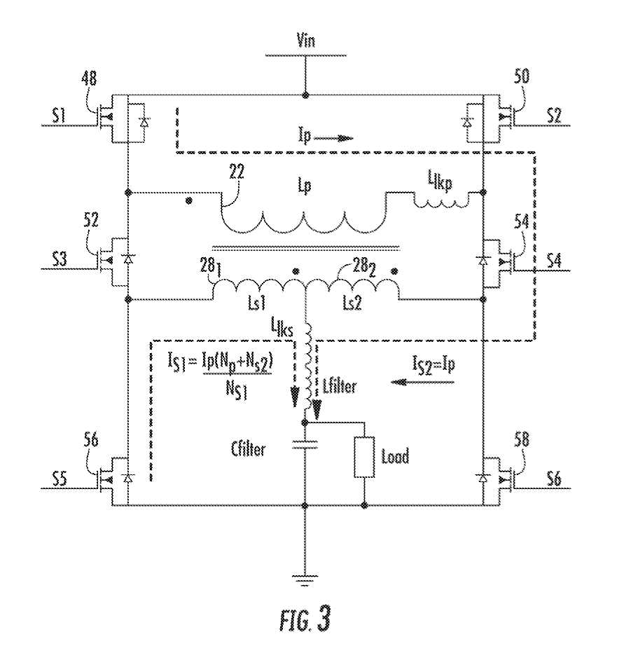

FIGS. 3-7 are schematic diagrams showing respective current flows through the power supply 10 of FIG. 1 during various operational states of an embodiment of the power supply, where the operational states correspond to respective portions of the timing diagram of FIG. 2 as further discussed below. Furthermore, some components (e.g., the current sensors, 24, 30, and 42) of the power supply 10 have been omitted from FIGS. 3-7 for clarity.

Referring to FIGS. 1-7, the operation of an embodiment of the power supply 10 is described.

Referring to FIG. 2, at a time t₁, the controller 16 generates the signals S1 and S5 logic high, generates the signals S3 and S4 logic low, and transitions the signals S2 and S6 from logic high to logic low such that the transistors 48 and 56 are on, the transistors 52 and 54 are off, and the transistors 50 and 58 transition from on to off.

In response to the transistor 50 turning off, the discharging current Ip that was flowing from Vin, through the transistor 50, through the primary winding 22, and through the transistor 48 now flows through the body diodes of the transistors 54 and 58, through the primary winding, through the transistor 48, and to Vin.

At a time t₂, which is delay d₁ after the time t₁ sufficient to allow the body diode of the transistor 54 to be conducting the current Ip at time t₂ per above, the controller 16 transitions S4 from logic low to logic high such that the transistor 54 transitions from off to on. Because its body diode is conducting when it turns on, the transistor 54 may achieve zero-voltage switching (ZVS), which may reduce the power that the transistor 54 dissipates while turning on. In an alternate embodiment, the controller 16 may wait until the time t₂ to transition S6 low so that the transistor 58 stays on at least until the transistor 54 transitions from off to on. By keeping the transistor 58 on, the current Ip conducted by the body diode of the transistor 54 flows through the on transistor 58 instead of through the body diode of the transistor 58, thus potentially reducing the power dissipated by the transistor 58 during this time period. In another alternate embodiment, S4 may transition high at time t₁ such that the transistor 54 does not achieve ZVS.

At some time after time t₂, the time depending, e.g., on the leakage inductance Lₗₖₚ, the current Ip reverses direction, and begins to flow from Vin, through the on transistor 48, through the primary winding 22, through the on transistor 54, and through the secondary winding 28₂.

Consequently, during a portion D₁ of the switching period P_{sw}, a linearly increasing current Ip flows from Vin, through the on transistor 48, through the primary winding 22, through the on transistor 54, and through the secondary winding 28₂ as indicated by the longer dashed line in FIG. 3. Because this current Ip is being sourced by Vin, it may be thought of as a current that is energizing, e.g., charging, the leakage inductances Lₗₖₚ and Lₗₖₛ and the filter inductor 36 (if present).

Also during the portion D₁ of the switching period P_{sw}, an increasing magnetically induced current Is₁ circulates through the on transistor 56 and the secondary winding 28₁ as shown by the shorter dashed line in FIG. 3, where, as discussed above, Is₁=Ip(Np+Ns₂)/Ns₁.

At a time t₃, the controller 16 transitions S4 low to turn off the transistor 54, such that the off transistors 52 and electrically isolate the primary winding 22 from the secondary windings 28.

Also at time t₃, the current Is₂ that was flowing through the transistor 54 now begins to flow through the body diode of the transistor 58.

At a time t₄, which is a delay d₂ after the time t₃ sufficient to allow the body diode of the transistor 58 to be conducting the current Is₂ at time t₄ per above, the controller 16 transitions S6 from logic low to logic high to turn on the transistor 58. Because its body diode is conducting when it turns on, the transistor 58 may achieve zero-voltage switching (ZVS), which may reduce the power that the transistor 58 dissipates while turning on. Alternatively, the controller 16 may transition S6 from logic low to logic high at the time t₃ such that the transistor 58 does not achieve ZVS.

Also at the time t₄, the controller 16 transitions S2 from logic low to logic high to turn on the transistor 50, which may achieve ZVS to reduce power dissipation for reasons similar to those discussed above for the transistor 58. Alternatively, the controller 16 may transition S2 from logic low to logic high at the time t₃ such that the transistor 50 does not achieve ZVS.

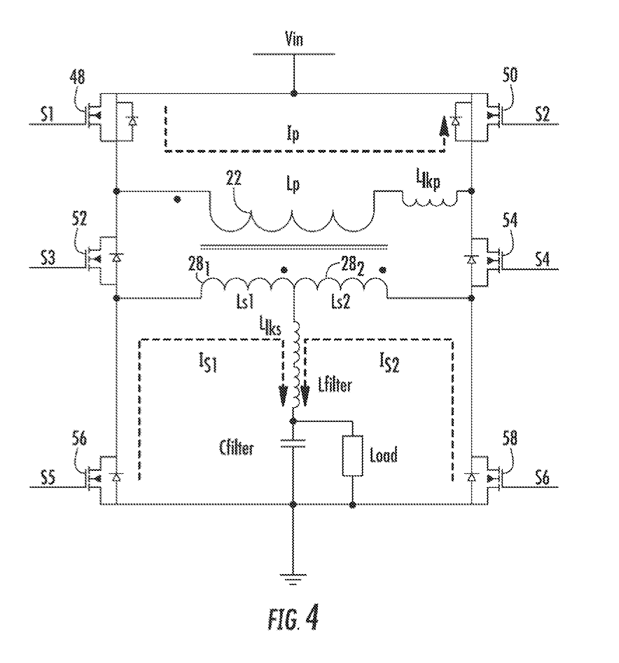

Consequently, during a portion D₂ of the switching period P_{sw}, a linearly decreasing current Ip flows from Vin, through the on transistor 48, through the primary winding 22, through the on transistor 50, and back to Vin as indicated by the upper dashed line in FIG. 4. Because this current Ip not being sourced by Vin (the transistors 48 and 50 effectively cause zero volts to be across the primary winding 22 by coupling both nodes of the primary winding to the input node 18), Ip may be thought of as a current that is de-energizing, e.g., discharging, the leakage inductance Lₗₖₚ.

Also, during the portion D₂ of the switching period P_{sw}, a linearly decreasing current Is₁ flows from ground, through the transistor 56, through the secondary winding 28₁, through the leakage inductance Lₗₖₛ, through the filter inductor 36 (if present), through the parallel combination of the filter capacitor 40 and the load 12, and back to ground as shown by the left-most most lower dashed line in FIG. 4; likewise, a linearly decreasing current Is₂ flows from ground, through the transistor 58, through the secondary winding 28₂, through the leakage inductance Lₗₖₛ, through the filter inductor 36 (if present), through the parallel combination of the filter capacitor 40 and the load 12, and back to ground as shown by the right-most lower dashed line in FIG. 4. Because the currents Is₁ and Is₂ are not being sourced by Vin, they may be thought of as currents that are de-energizing, e.g., discharging, the leakage inductance Lₗₖₛ; therefore, Is₁ and Is₂ may be similar to the “freewheeling” current(s) of a conventional buck converter.

In an embodiment, the portion D₂ of the switching period P_{sw} is short enough such that the currents Ip, Is₁, and Is₂ do not decay to or below zero. The maximum length of D₂ before these currents decay to zero depends, e.g., on the sizes of the leakage inductances Lₗₖₚ and Lₗₖₛ, on the size of the filter inductance L_{filter} (if the filter inductor 36 is present), and on the size of the load 12. Therefore, a designer may set the sizes Lₗₖₚ, Lₗₖₛ, ad L_{filter} (If present) such that during steady-state operation, Ip, Is₁, and Is₂ do not decay to zero or reverse direction (i.e., go below zero).

At a time t₅, the controller 16 transitions the signals S1 and S5 from logic high to logic low, generates the signals S3 and S4 logic low, and generates the signals S2 and S6 logic high such that the transistors 48 and 56 transition from on to off, the transistors 52 and 54 are off, and the transistors 50 and 58 are on.

In response to the transistor 48 turning off, the discharging current Ip that was flowing from Vin, through the transistor 48, through the primary winding 22, and through the transistor 50 now flows through the body diodes of the transistors 52 and 56, through the primary winding, through the transistor 50, and to Vin.

At a time t₆, which is a delay d₃ after the time t₅ sufficient to allow the body diode of the transistor 52 to be conducting the current Ip at the time t₆ per above, the controller 16 transitions S3 from logic low to logic high such that the transistor 52 transitions from off to on. Because its body diode is conducting when it turns on, the transistor 52 may achieve ZVS to reduce power dissipation. In an alternate embodiment, the controller 16 may wait until the time t₆ to transition S5 low so that the transistor 56 stays on at least until the transistor 52 transitions from off to on. By keeping the transistor 56 on, the current Ip conducted by the body diode of the transistor 52 flows through the on transistor 56 instead of through the body diode of the transistor 56, thus potentially reducing the power dissipated by the transistor 56 during this time period. In another alternate embodiment, the controller 16 may transition S3 high at time t₅ such that the transistor 52 does not achieve ZVS.

At some time after the time t₆, the time depending, e.g., on the leakage inductance Lₗₖₚ, the current Ip reverses direction, and begins to flow from Vin, through the on transistor 50, through the primary winding 22, through the on transistor 52, and through the secondary winding 28₁.

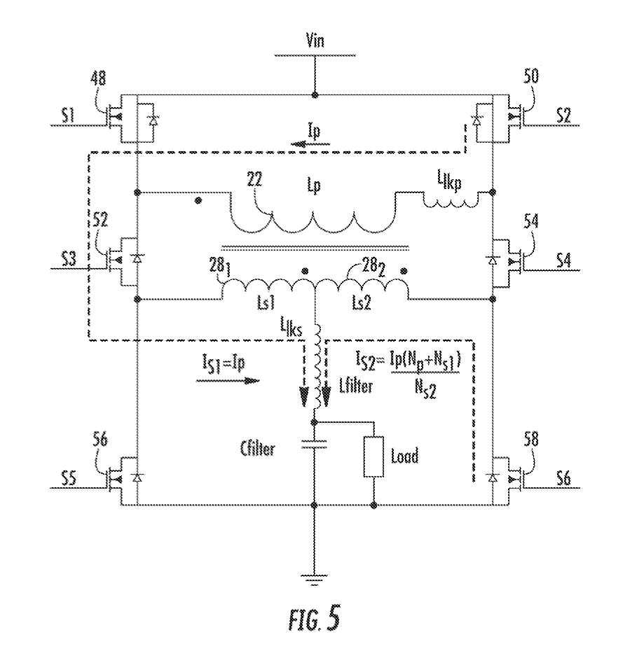

Consequently, during a portion D₃ of the switching period P_{sw}, a linearly increasing charging current Ip flows from Vin, through the on transistor 50, through the primary winding 22, through the on transistor 52, and through the secondary winding 28₁ as indicated by the longer dashed line in FIG. 5.

Also during the portion D₃ of the switching period P_{sw}, an increasing magnetically induced current Is₂ circulates through the on transistor 58 and the secondary winding 28₂ as shown by the shorter dashed line in FIG. 5, where, as discussed above, Is₂=Ip(Np+Ns₁)/Ns₂.

At a time t₇, the controller 16 transitions S3 low to turn off the transistor 52 such that the off transistors 52 and 54 electrically isolate the primary winding 22 from the secondary windings 28.

Also at the time t₇, the current Is₁ that was flowing through the transistor 52 now begins to flow through the body diode of the transistor 56.

At a time t₈, which is delay d₄ after the time t₇ sufficient to allow the body diode of the transistor 56 to be conducting the current Is₁ at the time t₈ per above, the controller 16 transitions S5 from logic low to logic high to turn on the transistor 56. Because its body diode is conducting when it turns on, the transistor 58 may achieve ZVS to reduce turn-on power dissipation in this transistor. Alternatively, the controller 16 may transition S5 from logic low to logic high at the time t₇ such that the transistor 56 does not achieve ZVS.

Also at the time t₈, the controller 16 transitions S1 from logic low to logic high to turn on the transistor 48, which may achieve ZVS to reduce power dissipation for reasons similar to those discussed above for the transistor 56. Alternatively, the controller 16 may transition S1 from logic low to logic high at the time t₇ such that the transistor 48 does not achieve ZVS.

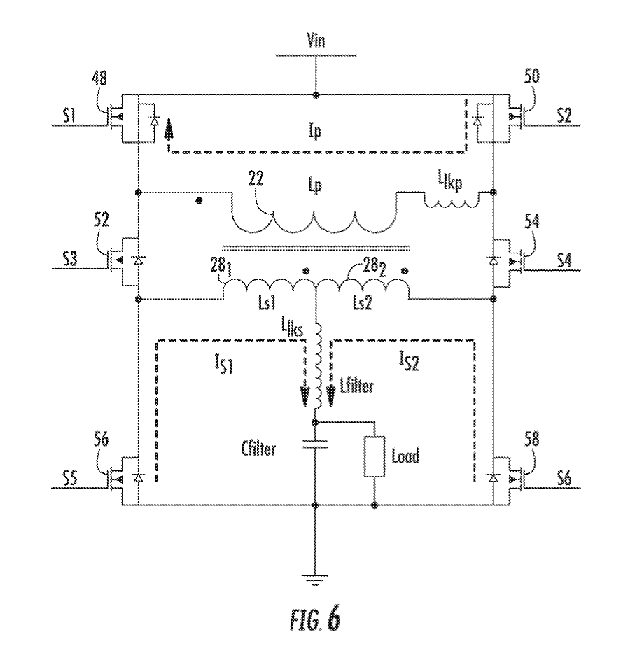

Consequently, during a portion D₄ of the switching period P_{sw}, a linearly decreasing discharging current Ip flows from Vin, through the on transistor 50, through the primary winding 22, through the on transistor 48, and back to Vin as indicated by the upper dashed line in FIG. 6.

Also, during the portion D₄ of the switching period P_{sw}, a linearly decreasing discharging current Is₁ flows from ground, through the transistor 56, through the secondary winding 28₁, through the leakage inductance Lₗₖₛ, through the filter inductor 36 (if present), through the parallel combination of the filter capacitor 40 and the load 12, and back to ground as shown by the left-most lower dashed line in FIG. 6; likewise, a linearly decreasing discharging current Is₂ flows from ground, through the transistor 58, through the secondary winding 28₂, through the leakage inductance Lₗₖₛ, through the filter inductor 36 (if present), through the parallel combination of the filter capacitor 40 and the load 12, and back to ground as shown by the right-most lower dashed line in FIG. 6. In an embodiment, as discussed above in conjunction with FIG. 4 and the portion D₂ of the switching period P_{sw}, the portion D₄ of the switching period P_{sw} is short enough such that the currents Ip, Is₁, and Is₂ do not decay to or below zero.

At a time t₉, a new switching period P_{sw} begins, and the steady-state sequence described above in conjunctions with FIGS. 1-6 repeats.

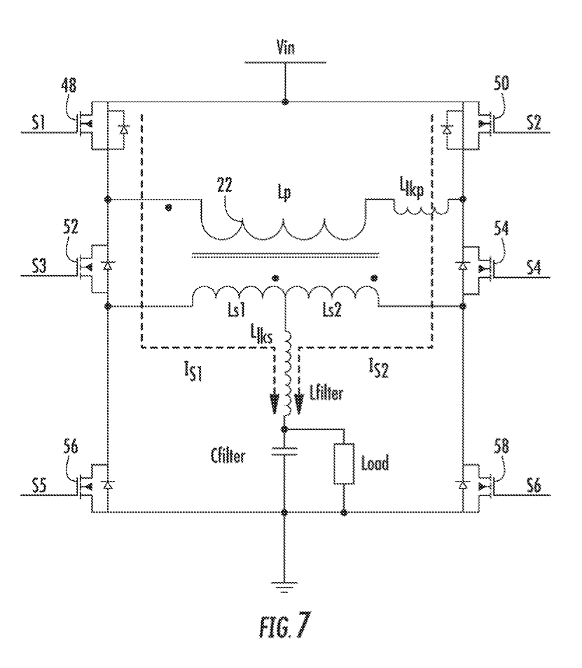

Still referring to FIGS. 1-6, alternate operational embodiments exist. For example, under heavy load conditions the charging portions D₁ and D₃ the switching period P_{sw} may increase, and the discharging portions D₂ and D₄ may decrease, without losing the transformer action, up to a theoretical maximum point of a 50% duty cycle (a charging current Ip always flowing in one direction or another) where D₂=D₄=0, and where ZVS may be unachievable for any of the transistors. Increasing the duty cycle above 50% would result in a high Iout mode for at least part of the switching period. An embodiment of the power supply 10 operating in a high Iout mode is discussed below in conjunction with FIG. 7.

Referring to FIGS. 1, 2, and 7, the operation of an embodiment of the power supply 10 during a high Iout period is described. For example, the power supply 10 may enter a high Iout mode in response to a step-up load transient, which, as discussed above, occurs when the current sunk by the load 12 increases relatively suddenly and significantly. Although a high Iout period is described as commencing while the power supply 10 is in a discharging state such as that described above in conjunction with FIG. 4 and the portion D₂ of the steady-state switching period P_{sw}, it is understood that the below-described operation may be similar if the high Iout period commences while the power supply 10 is in another state. Furthermore, although described as occurring in response to a step-up load transient, a high Iout period may occur in response to other conditions, and may even occur as a portion of the steady-state switching period P_{sw} depending on the design of the power supply 10.

Some time before a time t₁₀, the controller 16 senses a step-up load transient. For example, the controller 16 may sense the step-up load transient by sensing a relatively sudden drop in Vout that exceeds a threshold drop. Because there exist conventional techniques for detecting a step-up load transient, further details of such techniques are omitted for brevity.

At the time t₁₀, the controller transitions S5 and S6 low to transition the transistors 56 and 58 from on to off.

Therefore, the currents Is₁ and Is₂ that were flowing through the on transistors 56 and 58 now flow through the body diodes of these transistors.

Then, at a time t₁₁, which is a delay d₅ after the time t₁₁ sufficient to allow the transistors 56 and 58 to turn off, the controller 16 transitions S3 and S4 from logic low to logic high to turn on the transistors 52 and 54.

Therefore, during a time period Pₜᵣₐₙₛᵢₑₙₜ, the transistors 48, 50, 52, and 54 are on, and the transistors 56 and 58 are off, such that a charging current flows from Vin, through the on transistors 48 and 52, through the secondary winding 28₁, and to the load 12, and such that a charging current Is₂ flows from Vin, through the on transistors 50 and 54, through the secondary winding 28₂, and into the load 12. Because Vin is effectively applied directly to the secondary windings 28₁ and 28₂ via the on transistors 48 and 52, and 50 and 54, respectively, the currents Is₁ and Is₂ may increase more quickly to meet the rather sudden increased current demand of the load 12.

At some time after the time t₁₁ but before a time t₁₂, the controller 16 senses that Iout has reached a level that is substantially sufficient to satisfy the increased current demands of the load 12. For example, the controller 16 may sense that Vout has risen above a threshold, or the controller may limit the transient period Pₜᵣₐₙₛᵢₑₙₜ to a fixed length. Because there exist conventional techniques for detecting the end of a step-up load transient, further details of such techniques are omitted for brevity.

At the time t₁₂, the controller 16 transitions S1 and S4 from logic high to logic low to turn off the transistors 48 and 54 such that the power supply 10 transitions to the state discussed above in conjunction with FIG. 5 and the portio D₄ of P_{sw}. But it is understood that the controller 16 may control S1-S6 so as to transition the power supply 10 to another suitable state.

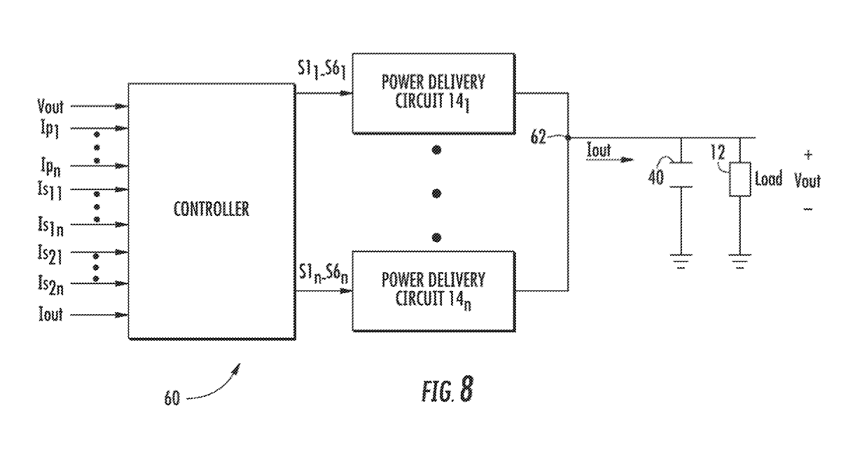

FIG. 8 is a diagram of a power supply 60, which is similar to the power supply 10 of FIGS. 1 and 2-7 except that the power supply 60 includes more than one power-delivery circuit 14. Therefore, the supply 60 may be able to deliver a higher current Iout to the load 12 than the supply 10.

A controller 62 receives Vout and Iout, receives from each power-delivery circuit 14₁-14ₙ respective signals Ip₁-Ipₙ, Is₁₁-Is₁ₙ, and Is₂₁-Is₂ₙ, and provides to each power-delivery circuit respective sets of switching signals S1₁-S6₁ to S1ₙ-S6ₙ.

The output currents from the power-delivery circuit 14₁-14ₙ are summed at a node 62 to generate Iout, and the controller 16 may balance these output currents, and the currents Is₁ and Is₂ of each delivery circuit 14, as discussed above in conjunction with FIG. 1. Also, the filter capacitor 40 of each power-delivery circuit 14₁-14ₙ may be replaced with a single filter capacitor 40 (or multiple filter capacitors 40 in parallel).

As discussed above in conjunction with FIG. 1, the filter inductor 36 may be omitted or there may be multiple filter inductors, and there may be multiple filter capacitors 40.

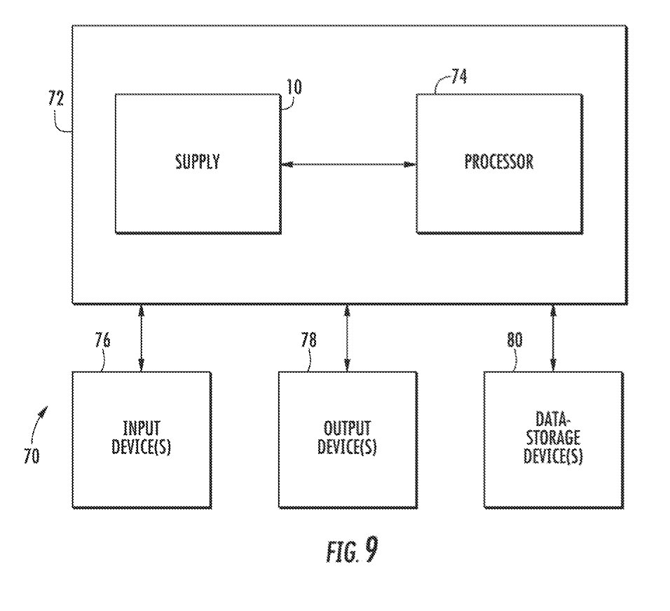

FIG. 9 is a block diagram of an embodiment of a computer system 70, which incorporates an embodiment of the power supply 10 of FIGS. 1 and 3-7, an embodiment of the power supply 60 of FIG. 8, or embodiments of both the supplies 10 and 60. Although the system 70 is described as a computer system, it may be any system for which an embodiment of the power supply 10 or the power supply 60 is suited. Furthermore, for clarity, the system 70 is described below as including the power supply 10 of FIG. 1.

The system 70 includes computing circuitry 72, which, in addition to the supply 10, includes a processor 74 powered by the supply, at least one input device 76, at least one output device 78, and at least one data-storage device 80.

In addition to processing data, the processor 74 may program or otherwise control the supply 10. For example, the functions of the controller 16 (FIG. 1) may be performed by the processor 74.

The input device (e.g., keyboard, mouse) 76 allows the providing of data, programming, and commands to the computing circuitry 72.

The output device (e.g., display, printer, speaker) 78 allows the computing circuitry 72 to provide data in a form perceivable by a human operator.

And the data-storage device (e.g., flash drive, hard disk drive, RAM, optical drive) 80 allows for the storage of, e.g., programs and data.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

What is claimed is:

1. A controller, comprising:
circuitry operable:
to allow a first current to flow through a first winding of a power supply, through a second winding of the power supply, and to an output node of the power supply during a first portion of a supply period; and
to allow a second current to flow through the first winding, through a third winding of the power supply, and to the output node during a second portion of the supply period.

2. The controller of claim 1 wherein the circuitry is operable:
to allow the first current to flow by closing a first switch disposed between the first and second windings; and
to allow the second current to flow by closing a second switch disposed between the first and third windings.

3. The controller of claim 1 wherein the circuitry is operable:
to allow the first current to flow by closing a first switch disposed between an input node and a first node of the first winding and by closing a second switch disposed between a second node of the first winding and the second winding; and
to allow the second current to flow by closing a third switch disposed between the input node and the second node of the first winding and by closing a fourth switch disposed between the first node of the first winding and the third winding.

4. The controller of claim 1 wherein the circuitry is operable:
to allow the first current to flow in a direction through the first winding; and
to allow the second current to flow in an opposite direction through the first winding.

5. The controller of claim 1 wherein the circuitry is further operable:
to allow a third current to flow through the third winding to the output node while the first current is flowing through the first and second windings; and
to allow a fourth current to flow through the second winding to the output node while the second current is flowing through the first and third windings.

6. The controller of claim 1 wherein the circuitry is further operable:
to allow a third current to flow through the third winding to the output node while the first current is flowing through the first and second windings by closing a first switch disposed between a reference node of the power supply and the third winding; and
to allow a fourth current to flow through the second winding to the output node while the second current is flowing through the first and third windings by closing a second switch disposed between the reference node and the second winding.

7. The controller of claim 1 wherein the circuitry is further operable:
to allow a third current that is magnetically induced by the first current to flow through the third winding to the output node while the first current is flowing through the first and second windings; and
to allow a fourth current that is magnetically induced by the second current to flow through the second winding to the output node while the second current is flowing through the first and third windings.

8. The controller of claim 1 wherein the circuitry is further operable:
to allow a third current to flow through the third winding to the output node while the first current is flowing through the first and second windings, the third current being substantially equal to a product of the first current and a sum of the number of turns of the first and second windings divided by the number of turns of the third winding; and
to allow a fourth current to flow through the second winding to the output node while the second current is flowing through the first and third windings, the fourth current substantially equal to a product of the second current and a sum of the number of turns of the first and third windings divided by the number of turns of the second winding.

9. The controller of claim 1 wherein the circuitry is further operable to regulate a voltage at the output node by controlling respective lengths of the first and second portions of the supply period.

10. The controller of claim 1 wherein the circuitry is further operable to cause a parameter of the first current to substantially equal a same parameter of the second current by controlling respective lengths of the first and second portions of the supply period.

11. The controller of claim 1 wherein the circuitry is further operable to cause an average magnitude of the first current to substantially equal an average magnitude of the second current by controlling respective lengths of the first and second portions of the supply period.

12. The controller of claim 1 wherein the circuitry is further operable to allow a third current to flow through the first winding, a fourth current to flow through the second winding, and a fifth current to flow through the third winding during a third portion of the supply period.

13. The controller of claim 1 wherein the circuitry is further operable to allow a third current to flow through the first winding, a fourth current to flow through the second winding, and a fifth current to flow through the third winding during a third portion of the supply period by electrically isolating the first winding from the second and third windings.

14. The controller of claim 1 wherein the circuitry is further operable to couple the second winding and a third winding to an input node of the power supply in response to an increase in a current sunk from the output node, the third winding also coupled to the output node.

15. A power supply, comprising:
an input node;
an output node operable to carry a regulated output signal;
a reference node;
a first winding having a first node coupled to the input node and having a second node;
a second winding having a first node coupled to the output node and having a second node;
a first switch coupled between the input node and the second node of the first winding;
a second switch coupled between the second nodes of the first and second windings; and
a third switch coupled between the second node of the second winding and the reference node.

16. The power supply of claim 15 wherein the first, second, and third switches respectively comprise first, second, and third transistors.

17. The power supply of claim 15 wherein the first and second windings are magnetically coupled.

18. The power supply of claim 15, further comprising:
a fourth switch coupled between the input node and the first node of the first winding;
a third winding having a first node coupled to the output node and having a second node; and
a fifth switch coupled between the first node of the first winding and the second node of the third winding; and
a sixth switch coupled between the second node of the third winding and the reference node.

19. The power supply of claim 15 wherein the output node is operable to carry a regulated output voltage.

20. The power supply of claim 15, further comprising a controller coupled the output node and the first, second, and third switches.

21. The power supply of claim 15, further comprising a sensor operable to provide an indication of a magnitude of a current flowing through the first winding.

22. The power supply of claim 15, further comprising a sensor operable to provide an indication of a magnitude of a current flowing through the second winding.

23. The power supply of claim 15, further comprising a sensor operable to provide an indication of a magnitude of current flowing into the output node.

24. A system, comprising;
a power supply, comprising:
an input node;
an output node operable to carry a regulated output signal;
a reference node;
a first winding having a first node coupled to the input node and having a second node;
a second winding having a first node coupled to the output node and having a second node;
a first switch coupled between the input node and the second node of the first winding;
a second switch coupled between the second nodes of the first and second windings; and
a third switch coupled between the second node of the second winding and the reference node; and
an integrated circuit coupled to the output node of the power supply.

25. The system of claim 24 wherein at least one component of the power supply and the integrated circuit are disposed on a same integrated circuit die.

26. The system of claim 24 wherein at least one component of the power supply and the integrated circuit are disposed on respective integrated circuit dies.

27. The system of claim 24 wherein the power supply further comprises a power-supply controller.

28. The system of claim 24 wherein the integrated circuit comprises a processor.

29. A method, comprising:
allowing a first current to flow through a first winding of a power supply, through a second winding of the power supply, and to an output node of the power supply during a first portion of a supply period; and
allowing a second current to flow through the first winding and a third current to flow through the second winding during a second portion of the supply period.

30. The method of claim 29 wherein:
allowing the first current to flow comprises serially coupling the first winding to the second winding; and
allowing the second and third currents to flow comprises electrically isolating the first winding from the second winding.

31. The method of claim 29 wherein:
allowing the first current to flow comprises closing a switch coupled between the first and second windings; and
allowing the second and third currents to flow comprises opening the switch.

32. The method of claim 29 wherein allowing the second and third currents to flow comprises coupling both nodes of the first winding to the input node and coupling both nodes of the second winding to a reference node of the power supply.

33. The method of claim 29, further comprising allowing a fourth current to flow through the first winding, through a third winding of the power supply, and to the output node during a third portion of the supply period.

34. The method of claim 29, further comprising:
allowing a fourth current to flow through the first winding, through a third winding of the power supply, and to the output node during a third portion of the supply period; and
allowing a fifth current to flow through the third winding during the second portion of the supply period.

35. The method of claim 34 wherein:
allowing the fourth current to flow comprises serially coupling the first winding to the third winding and electrically isolating the first winding from the second winding; and
allowing the fifth current to flow comprises electrically isolating the first winding from the second and third windings.

36. The method of claim 29, further comprising allowing the first current to magnetically induce a fourth current to flow through a third winding during the first portion of the supply period.

37. The method of claim 29, further comprising causing respective fourth and fifth currents to flow through the second winding and a third winding to the output node in response to a transient increase in a load current.

38. The method of claim 29, further comprising hindering current flow through the first winding in response to a transient increase in a load current.

39. A method, comprising:
allowing a first current to flow through a first winding of a power supply, through a second winding of the power supply, and to an output node of the power supply during a first portion of a supply period; and
allowing a second current to flow through the first winding, through a third winding of the power supply, and to the output node during a second portion of the supply period.

40. A regulator, comprising:
an input node;
an output node operable to carry a regulated output signal;
a first winding having first and second nodes;
a second winding having a first node coupled to the output node and having a second node;
a first stage operable to selectively couple the first and second nodes of the first winding to the input node; and
a second stage operable to selectively couple the second node of the second winding to one of the first and second nodes of the first winding.

41. The regulator of claim 40, further comprising:
a reference node; and
a third stage operable to selectively couple the second node of the second winding to the reference node.

42. The regulator of claim 40, further comprising a controller operable to control the first and second stages.

43. The regulator of claim 40, further comprising:
a third winding having a first node coupled to the output node and having a second node; and
wherein the second stage is operable to selectively couple the second node of the third winding to the other of the first and second nodes of the first winding.

44. The regulator of claim 43, further comprising:
a reference node; and
a third stage operable to selectively couple the second nodes of the second and third windings to the second input node.
